(19) United States
(12) Patent Application Publication
(10) Pub. No.: US 2011/0295825 A1
(43) Pub. Date: Dec. 1, 2011

(54) Method and System for Interacting with a Plurality of Search Engines

(76) Inventors: Ali Davar, Vancouver (CA); Kevin Leyton-Brown, Vancouver (CA)

(21) Appl. No.: 13/001,426

(22) PCT Filed: Jun. 29, 2009
(86) PCT No.: PCT/CA2009/000910

§ 371 Date: Aug. 15, 2011

Related U.S. Application Data
(60) Provisional application No. 61/077,138, filed on Jun. 30, 2008.

(51) Int. Cl. G06F 17/30

(52) U.S. Cl. 707/706; 707/E17.108; 707/E17.032

(57) ABSTRACT

A way to conduct multiple distinct searches and to present the respective result subsets 176 together but distinctly. More particularly a way to order the results subsets 176 in relation to each other and to present the result subsets 176 in that order together but distinctly, such that a user can easily scan between the result subsets 176 to adjust the focus of his research.

### BACKGROUND OF THE INVENTION

1. Field of the Invention

The present invention relates to ways to interact with a search engine. More particularly, it relates to ways to order results from multiple search engines for presentation together but distinctly.

2. Description of the Related Art

The Holy Grail of search engines would conduct an exhaustively comprehensive search and present the results in a way that groups and highlights those most relevant to the searcher's particular needs at that instant. Just as with the Holy Grail, such a valuable search engine has proved elusive and some would say mythical.

One relatively old approach has been to create meta-search engines, in which a single set of search terms is broadcast to multiple search engines and then results from all the search engines are aggregated, either into a single result list or into a result list segregated by search engine. This approach arguably increases comprehensiveness, but not relevancy. The results can include multiple instances of the same item and there is generally no clear distinction between all of the search engines.

For this reason, some have urged against presenting multiple subsets of results. For example U.S. Pat. No. 7,206,778 granted to Andreas Bode et. al. on Apr. 17, 2007 for a “Text Search Ordered Along One or More Dimensions” teaches a method of conducting multiple searches and then combining the results into a single homogenous result set in which duplicate results are removed and the remaining results are assigned a rank in a common ranking scheme within the homogenous result set. This consolidation saves the user time that might otherwise be spent combing through overlapping subsets and ranking results between subsets.

While the Bode approach has its merits, it has its shortcomings as well. The process of homogenization destroys useful information—the link between a particular search result and the search that produced it. One value of this link is illustrated in U.S. Ser. No. 11/092,387 (US20060106788) filed by Brady D. Forrest on Mar. 29, 2005 (and claiming priority back to Oct. 29, 2004) for a “Computer-Implemented System and Method for Providing Authoritative Answers to a General Information Search”. Forest teaches the practice of searching both a general and an expert dataset and presenting the respective results at different locations on the same display to help a user weigh the quality of each result by associating it with its respective dataset. For example, a big, general and unedited dataset, such as the World Wide Web, is searched to provide broad results of unknown credibility, but a smaller dataset of expert answers assembled and vetted by editors is also searched to provide more credible results when available. The data in the expert dataset is created and vetted expressly for the purposes of growing a dataset of expert answers and is specially structured as a question, an answer and a credibility score in combination. In contrast, the Web dataset grows more organically and is more freeform. Forrest does not provide any teaching on overlaying a credibility measure on a large, organic dataset like the Web.

Thus, the Forrest invention is not suitable for general application but is limited by the prerequisites for its datasets; the two datasets are distinct and one of the datasets must include a measure of credibility. U.S. Ser. No. 10/021,474 (US20030084032) filed by Sukhminder Grewal and Mir Faiz Mohammad on Oct. 30, 2001 for “Methods and Systems for Performing a Controlled Search” teaches the practice of conducting multiple queries on the same large, organic dataset—for example the Web—with the queries having broader to narrower scope and presenting such result sets one at a time, but allowing a user to switch between result sets in order, so as to in effect zoom in or out on the search results.

While each of these inventions has its purpose, what is needed is a way to conduct multiple distinct searches on a universe of information and to present the respective result subsets together but distinctly in a manner that helps each user to skim to the subset that most interests him in particular. More specifically, what is needed is a way to order the results subsets with respect to each other and to present the result subsets in that order together but distinctly, such that a user can easily scan between the results subsets to adjust the focus of his research.

### SUMMARY OF THE INVENTION AND ADVANTAGES

The present invention is directed to such a solution.

According to one aspect of the present invention, there is provided a method of presenting a result set of a plurality of searches of a universe of content, the plurality of searches returning respective result subsets of indicants that in union form the result set, comprising serving a page that presents the subsets, ordered with respect to each other according to scope, together but distinctly such that each subset presents a distinct cue to its respective scope.

According to a second aspect of the present invention, there is provided an apparatus for presenting a result set of a plurality of searches of a universe of content, the plurality of searches returning respective result subsets of indicants that in union form the result set, comprising means for serving a page that presents the subsets, ordered with respect to each other according to scope, together but distinctly such that each subset presents a distinct cue to its respective scope.

According to a third aspect of the present invention, there is provided a computer-readable medium having computer-executable instructions for performing a method of presenting a result set of a plurality of searches of a universe of content, the plurality of searches returning respective result subsets of indicants that in union form the result set, comprising serving a page that presents the subsets, ordered with respect to each other according to scope, together but distinctly such that each subset presents a distinct cue to its respective scope.

According to a fourth aspect of the present invention, there is provided a carrier wave communicating a computer-readable signal encoding computer-executable instructions for performing a method of presenting a result set of a plurality of searches of a universe of content, the plurality of searches returning respective result subsets of indicants that in union form the result set, comprising serving a page that presents the subsets, ordered with respect to each other according to scope, together but distinctly such that each subset presents a distinct cue to its respective scope.

The universe might be the union of respective sub-universes searched by each respective one of the plurality of searches. Two of the respective sub-universes might have a non-null intersection set, or even each of the respective sub-universes may have a non-null intersection set with at least one other of the respective sub-universes, or in fact each pair of respective sub-universes might have a non-null intersection set. Each pair of respective sub-universes might even have an intersection set that is identical to one of the pair.

The plurality of searches might operate on the same search terms or on the same query.

Presenting the ordered subsets together but distinctly might include: presenting the ordered subsets adjacently on the page such that the cue is position, presenting the ordered subsets in respective windows on the same page, presenting each of the ordered subsets adjacent to a respective distinguishing indicia, presenting each of the ordered subsets in a respective distinguishing color, or presenting each of the ordered subsets in a respective distinguishing font.

These aspects of the invention might also provide for ordering the subsets (176) with respect to each other according to scope.

Ordering the subsets might include ordering the subsets in the order of the respective searches.

Ordering the subsets might include ordering the subsets from: broad to narrow, deep to shallow, analyzed to synthesized, deduced to induced, investigative to explorative, tightly-related to the keywords searched to loosely-related to the keywords searched, literal to lateral, denotative to connotative, general to personal, concrete to abstract, machine-selected to human-selected, factual to speculative, historical to future-oriented, global to local, simple to complicated, short to long, objective to subjective, search to recommendation, fact to opinion, deterministic to probabilistic, descriptive to prescriptive, static to dynamic, popular to specialist, biased to neutral, emotional to rational, dormant to active, controlled to open, unilingual to multilingual, corporate to personal, corporate to academic, leftwing to rightwing, innocent to mature, fictional to factual, personalized on the same basis as everyone to personalized by comparison to others, implicitly preferenced to explicitly preferenced, or keyword-based to natural-language-based.

Ordering the subsets might include ordering the subsets according to more than one dimension of scope.

According to a fifth aspect of the present invention, there is provided a method of presenting a result set of a plurality of keyword searches of content, the plurality of searches returning respective result subsets of indicants that in union form the result set, comprising serving a page that presents the subsets, ordered with respect to each other according to scope from tightly-related to the keywords searched to loosely-related to the keywords searched, together but distinctly such that each subset presents a distinct cue to its respective scope.

Serving might include serving a page that presents user-selectable labels representing categories of indicants in the result set, in at least one of the subsets, or in the one of the subsets that is most loosely-related to the keywords searched.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a topological diagram showing one embodiment a network of communication and computing devices connected together to implement a method and system for interacting with a search engine according to one aspect of the present invention.

FIG. 2 is an abstraction layer diagram of the communication and computing devices of FIG. 1, illustrating a hardware layer, operating system layers and an application program layer.

FIG. 3 is an abstraction layer diagram detailing the application program layer of FIG. 2 for configuring a communication and computing device as a web browser, a web server or a search engine.

FIG. 4 is a database structure diagram illustrating how a communication and computing device configured as a search engine maintains an indicant for each item of internet content catalogued.

FIG. 5 depicts a GUI window created by a communication and computing device configured as a web server for presentation at a communication and computing device configured as a web browser, the window including controls for submitting a search query, controls for presenting together but distinctly respective subsets of indicants resulting from three search engines processing the same query wherein the subsets are ordered with respect to each other.

FIG. 6 depicts four interrelated GUI windows created by a communication and computing device configured as a web server for presentation at a communication and computing device configured as a web browser, a first window including controls for submitting a search query, and second, third and fourth windows including controls for presenting together but distinctly respective subsets of indicants resulting from three search engines processing the same query wherein the subsets are ordered with respect to each other.

FIG. 7 depicts a single GUI window created by a communication and computing device configured as a web server for presentation at a communication and computing device configured as a web browser, the window including controls for presenting together but distinctly respective subsets of indicants resulting from three search engines processing the same query wherein the subsets are ordered with respect to each other and the order is cued by a respective distinctive font associated with each subset.

FIG. 8 depicts a single GUI window created by a communication and computing device configured as a web server for presentation at a communication and computing device configured as a web browser, the window including controls for presenting together but distinctly respective subsets of indicants resulting from three search engines processing the same query wherein the subsets are ordered with respect to each other and the order is cued by a respective distinctive color associated with each subset.

FIG. 9 depicts a single GUI window created by a communication and computing device configured as a web server for presentation at a communication and computing device configured as a web browser, the window including controls for presenting together but distinctly respective subsets of indicants resulting from four search engines processing the same query wherein the subsets are ordered with respect to each other from narrow to broad and the order is cued by a respective distinctive icons associated with each subset.

FIG. 10 depicts a single GUI window created by a communication and computing device configured as a web server for presentation at a communication and computing device configured as a web browser, the window including controls for presenting together but distinctly respective subsets of indicants resulting from three search engines processing the same query wherein the subsets are ordered with respect to each other from historical to future-oriented and the order is cued by a respective distinctive icons associated with each subset.

FIG. 11 depicts a single GUI window created by a communication and computing device configured as a web server for presentation at a communication and computing device configured as a web browser, the window including controls for presenting together but distinctly respective subsets of indicants resulting from three search engines processing the same query wherein the subsets are ordered with respect to each other from global to local and the order is cued by a respective distinctive icons associated with each subset.

FIG. 12 depicts a single GUI window created by a communication and computing device configured as a web server for presentation at a communication and computing device configured as a web browser, the window including controls for presenting together but distinctly respective subsets of indicants resulting from two search engines processing the same query wherein the subsets are ordered with respect to each other from general to personalized and the order is cued by a respective distinctive icons associated with each subset, and controls for presenting labels that categorize the indicants.

FIG. 13 depicts a GUI window created by a communication and computing device configured as a web server for presentation at a communication and computing device configured as a web browser, the window including controls for submitting a search query, controls for presenting together but distinctly respective subsets of indicants resulting from nine search engines processing the same query wherein the subsets are ordered with respect to each other along two axes, namely a broad to narrow axis and a past to future axis.

FIG. 14 is a flowchart of a process executing in a communication and computing device configured as a web server for submitting a search query to a plurality of search engines and presenting together but distinctly respective subsets of indicants resulting from the search engines processing the same query, wherein the subsets are ordered with respect to each other.

FIG. 15 is a flowchart of an augmented version of the process of FIG. 14, further including presenting labels that categorize the indicants and refining the search query to bias toward one of the labels.

FIG. 16 is a flowchart of another augmented version of the process of FIG. 14, further including sequencing the transmission of queries to the search engines and forwarding to later-queried search engines data related to searches performed by earlier-queried search engines, for example complete result subsets or categories.

### DETAILED DESCRIPTION OF THE INVENTION

1. Structure

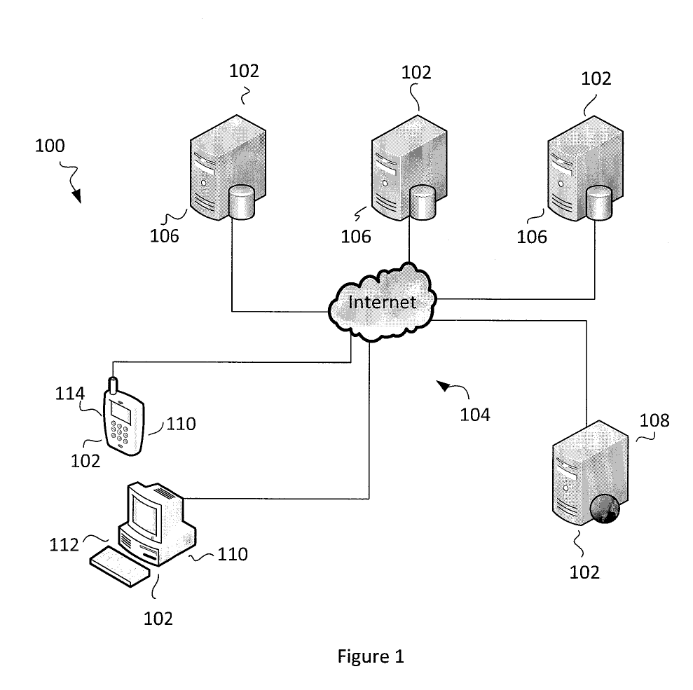

FIG. 1 depicts a system 100 of communication and computing devices 102 connected together through an internetwork 104 to provide one embodiment of a system 100 for interacting with a plurality of search engines 106 according to one aspect of the present invention. In this regard, each communication and computing device 102 might be configured as a search engine 106, a web server 108 or a web browser 110.

A web browser 110 might be a duly configured general purpose programmable computer 112 or a more purpose-specific device 114, such as a smartphone, a pocket browser, or portable media viewer with a wireless modem.

A web server 108 or a search engine 106 might similarly be a duly configured general purpose programmable computer 112, as illustrated, but might also be a farm of such computers or one or more virtualized computers embodied as processes operating on a physical general purpose programmable computer 112. Such farmed or virtualized computers might themselves be distributed over their own local or wide area network, not shown.

In essence, the search engine 106, the web server 108 and the web browsers 110 are roles or functions performed in the system 100 by properly configured devices 102. Multiple roles or functions could be performed by one device 102 and one role or function could be distributed over multiple devices 102. The specific character of a device 102 (and more generally the hardware) and the network topology is not important so long as it supports the performance of the assigned roles or functions.

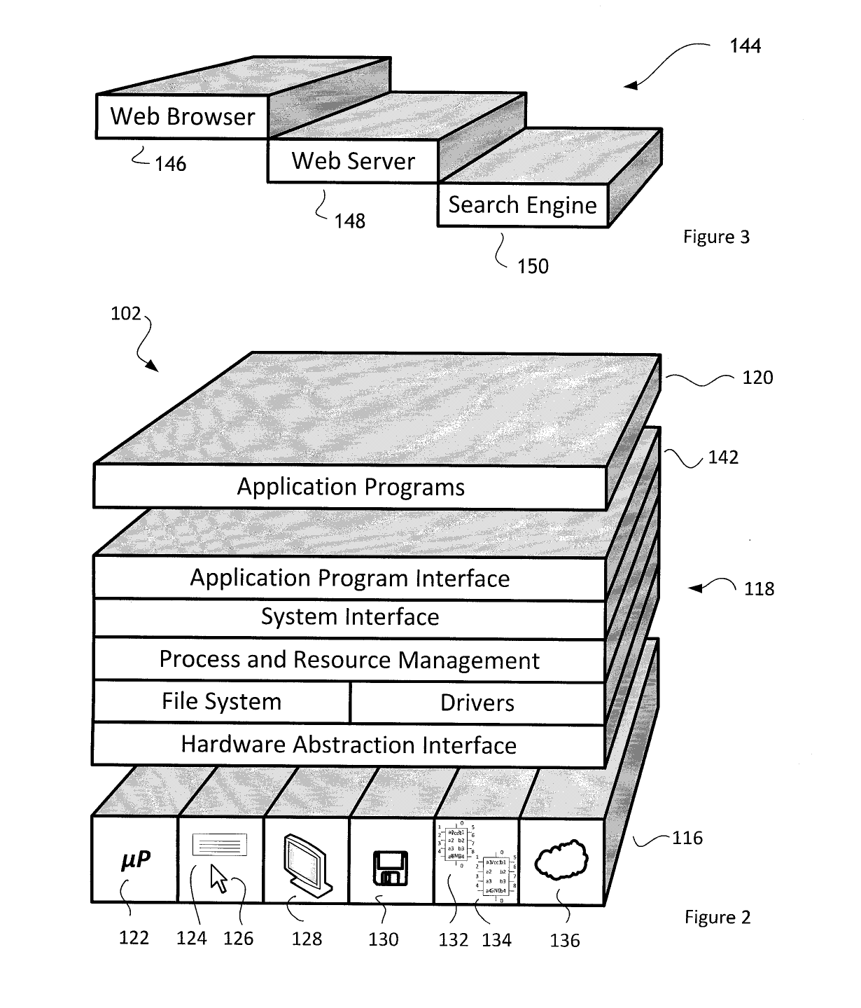

FIG. 2 illustrates a common construction of the search engine 106, the web server 108 and the web browser 110. These devices 102 have a hardware layer 116, an operating system layer 118 and an application program layer 120. Those skilled in the art will recognize the aspects in which like virtualized hardware and devices 102 depart from like physical ones.

The hardware layer 116 provides the device 102 with computing and communication hardware, including: (a) a processor 122 to execute processes of instructions and compute data, (b) user-input hardware such as a keyboard 124 and a selection device 126 (for example a mouse 126) to receive input from a user, (c) user-output hardware such as a video display 128 to provide information to a user, (d) mass storage 130 such as electromagnetic, optical or nonvolatile solid-state media to store data and processing instructions, (e) memory such as read only memory 132 and random access memory 134 to store data and processing instructions, and (f) a network interface 136 to support communication with other devices 102 in accordance with known protocols such as TCP/IP, all interconnected by buses such as address and data buses and control lines such as interrupt and clock lines and such other connections and components as is conventionally required and known to in the art.

Stored in a portion of the read only memory 132 and the mass storage 130 are the components of the operating system layer 118, for example LINUX® or Microsoft® Windows® CE® or VISTA®. The operating system layer 118 provides the basic instructions to direct the processor 122 how to interact with the other hardware described above and more generally how to perform the functions of a general purpose programmable computer 112, including storing, accessing and computing data, and communicating with other devices 102.

The operating system layer 118 also presents an application program interface 142 to the application program layer 120, so the processor 122 can execute more sophisticated combinations of processes under the direction of higher level application programs 144 stored in mass storage 130 and loaded into RAM 134 for execution.

FIG. 3 illustrates three such application programs 144, namely a web browser application program 146 such as Microsoft® Internet Explorer®, Firefox®, Safari® or Opera® to configure a device 102 as a web browser 110, a web server application program 148 such as Apache® Apache®, Microsoft® Internet Information Services® or Google® Google Web Server® to configure a device 102 as a web server 108, and a search engine application program 150 such as Google®, Yahoo!®, Microsoft® Live Search® or Ask.com® to configure a device 102 as a search engine 106.

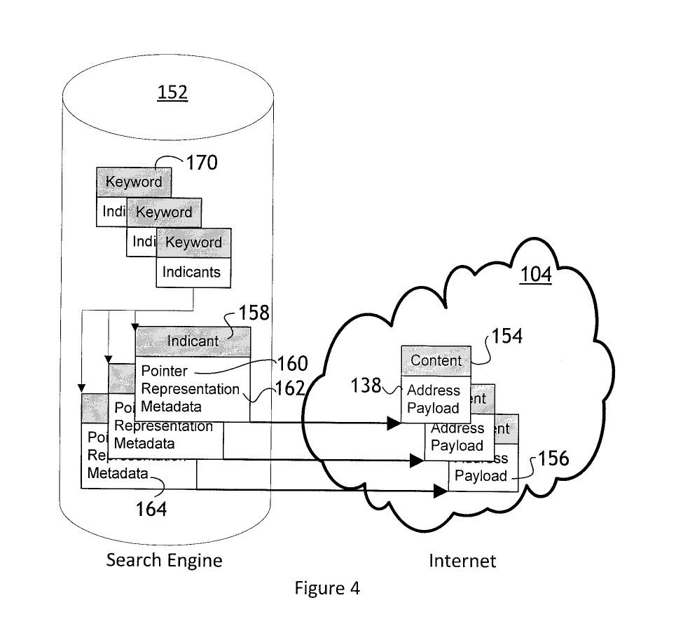

As best seen with reference to FIG. 4, a device 102 configured by the search engine application program 150 to be a search engine 106 maintains a search engine database 152 that catalogs the content items 154 it finds on the Internet 104. Each content item 154 may be understood as a payload 156 locatable at a unique address 138 on the Internet 104. The payload 156 is code encoding information in any medium or form, including human-readable form such as text, graphic, audio or video and machine-readable form such as source or object code or data files.

For each content item 154, the search engine database 152 maintains an indicant 158, comprising a pointer 160 to the Internet 104 address 138 where the respective content item 154 resides, a representation 162 of the payload 156, and metadata 164 about the content item 154. The representation 162 might be a complete cache of the payload 156 or else it might be a précis suitable for displaying in search result sets 166, for example a thumbnail, a clip, an icon 178, a summary or a portion of the payload 156. The metadata 164 would include data the search engine 106 program uses to contextualize the content item 154, for example ranking data.

The search engine database 152 also maps keywords 168 to indicants 158, such that a search for a particular keyword 168 will locate the applicable indicants 158, ranked in accordance with the metadata 164. This mapping might be done through indexing keyword records 170, as illustrated, or otherwise.

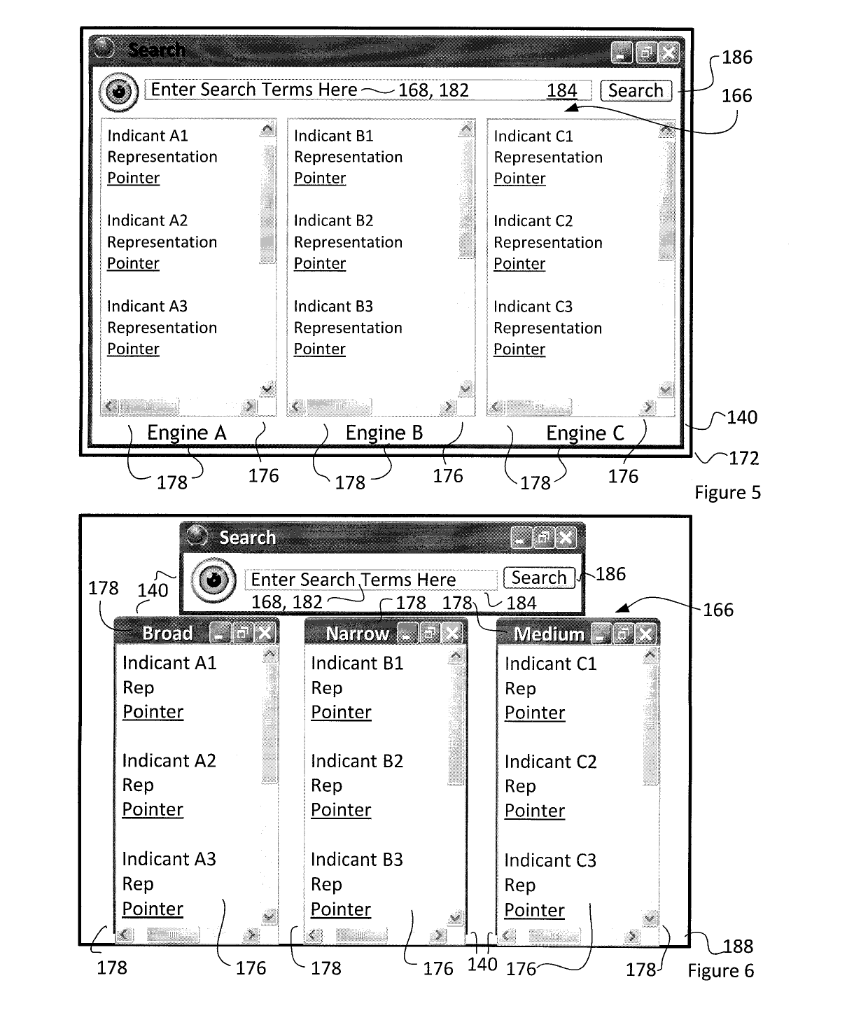

FIG. 5 shows a first embodiment page 172 of search results served by the web server 108 to the web browser 110 incorporating a set of search results 166 from multiple search engines 106. In this regard, those skilled in the art will appreciate that the multiple search engines 106 might be multiple instances of the same search engine 106 or one instance of the same search engine 106 queried multiple times, for example with different search parameters set so as to return different search results.

The set of search results 166 is the union of the search result subsets 176 returned by the respective search engines 106. The search result subsets 176 are presented together but distinctly on the first embodiment page 172 of search results, with a respective cue 178 indicating the correspondence between each of the search result subsets 176 and its respective search engine 106. As illustrated, each of the search result subsets 176 is presented in its own scrollable list and all the scrollable lists are presented adjacently. As illustrated, the cue 178 for each subset 176 is a legend (Engine A, Engine B, Engine C) and the position of the list (left, middle, right).

Although three subsets 176 are shown ordered, lesser or greater numbers of subsets 176 could be ordered with similarly beneficial effect. The user is able to focus the scope of his search simply by scanning his eyes from one subset 176 to another, quickly focusing in on the subset 176 of results with the scope that best matches his intentions. Because the subsets 176 are presented together but distinctly on one page, the user can make this assessment quickly and simply by scanning his eyes, without having to switch between windows 140 or drill-down through hyperlinks classifications or related pages, for example. With experience, the user can become even more efficient, predicting the best subset 176 to start his scanning for particular types of queries 182. Thus the cue 178 linking subset 176 to search engine 106 is in fact also a cue 178 indicating the scope of the subset 176.

Considering the first embodiment page 172 now in greater detail, the subsets 176 have been ordered with respect to each other in accordance with a particular metric, such that the subset 176 most characterized by the metric is presented in the left list, the moderately characterized subset 176 is presented in the middle list, and the least characterized subset 176 is presented in the right list. Those skilled in the art will recognize that this linear ordering is only one of many positional orders that might be used.

The result subsets 176 might be ordered according to many useful metrics of scope, for example from narrow to broad, from more deep to more shallow, from more analytic to more synthetic, from more deductive to more inductive, from more investigative to more explorative, from more tightly-related to the keywords 168 searched to more loosely-related to the keywords 168 searched, from more literal to more lateral, from more denotative to more connotative, more general to more personal, from more concrete to more abstract, from machine-selected in larger proportion to human-selected in larger proportion, from more factual to more speculative, from more historical to more future-oriented, more from global to more local, from more simple to more complicated, from shorter to longer, from more objective to more subjective, from more related to keywords 168 searched to more related to a user's broader interests, from more factual to more opinionated, from deterministic in larger proportion to probabilistic in larger proportion, from more descriptive to more prescriptive, from more structured to more random, from more popular to more specialist, from more biased to more neutral, from more emotional to more rational, from more dormant to more active, from more controlled to more open, from unilingual in larger proportion to multilingual in larger proportion, from more corporate to more personal, from more corporate to more academic, from more closely identified with a first ideology to more closely identified with a second ideology, from more innocent to more mature, from more fictional to more factual, from more personalized on the same basis as everyone to more personalized by comparison to others, from implicitly preferenced through behavior in larger proportion to explicitly preferenced through statement in larger proportion, from interpreting the query 182 more lexically to more interpreting the query 182 more semantically.

Thus if one is searching for introductory general knowledge on a topic, for example, he might prefer: broad, shallow, explorative, general, simple, or short search results. In contrast, if one is delving into a topic he is already somewhat familiar with, he may prefer: narrow, deep, investigative, personal, complicated, or long search results. If one is brainstorming, he may prefer: synthetic, inductive, lateral, connotative, abstract, speculative, probabilistic, prescriptive or dynamic search results. If one is searching vaguely for thinks that might interest someone such as himself, he might prefer: personal search results, which depending on the circumstances, might best be local, machine-selected, human-selected, personalized on the same basis as everyone, personalized by comparison to others, implicitly preferenced, explicitly preferenced search results or more generally a recommendation. If one is forecasting, he might prefer: future-oriented, probabilistic, prescriptive, dynamic results.

Those skilled in the art will recognize that scope is different from, and therefore does not include, metrics of quality, such as: good results versus bad results, right results versus wrong results, relevant results versus irrelevant results, authoritative results versus unauthoritative results or credible results versus incredible results, which are not beneficial axes for ordering result sets 166.

For example, historically-oriented search results and future-oriented search results might be equally “relevant” to their respective searchers and equally “irrelevant” to others and so such metrics of quality are imprecise and not generally useful. Alternatively, where a quality metric is of broad application, such as “wrong”, then results so designated would better be simply filtered out than ordered.

It will be appreciated that some results ordered by scope may also become ordered to a greater or lesser degree by some metric of quality; this side effect should not be seen to limit the ambit of the present invention, as such hybrid scenarios still deliver the benefits of the invention in the manner taught herein.

Those skilled in the art will also recognize that scope, which is inherently orderable, is different from classification, which in general is not orderable. For example, it is known for search engines 106 to classify result subsets 176 by data type (TIF files, MPS files, MPEG files, PDF files, HTML files), by kind of content 154 (news, maps, advertisements), by source (newspapers, particular search engines 106, blogs, special interest groups), by Internet 104 domain (.com, .net, .org), and by semantic concept.

Classifying is a unary operation. One examines an item in isolation to determine whether it has the requisite characteristics to be a member of a classification. One doesn't need to know anything about any other classification or any other item to determine whether or not an item is a member of a classification. In contrast, scoping and ordering are binary or n-ary operations—relational operations—that cannot be applied to a single item in isolation but only applied through comparison of two or more items along a predetermined dimension.

Classification delivers benefits to users; however, these are different from the benefits delivered by ordering. Classification helps users to quickly identify items that have the inherent characteristics required to be a member of a particular classification, thus helping users to filter out all the other items in a universe that are not of immediate interest. In contrast, ordering in effect overlays a relationship between subsets that cannot be inferred from any one item itself, thus helping users to scan between subsets 176 to focus their search.

More concretely, if a first classification of subset 176 proves fruitless, a user must assess the remaining classifications of subsets 176 and consider the next one to investigate. In contrast, if a first ordered subset 176 proves fruitless, a user merely considers how much he wants to increase or decrease his scope and delves into the corresponding ordered subset 176 without need for further consideration.

On occasion, weak ordering might be inferred as a secondary effect of classification. For example, when content 154 is classified into HTML format and PDF format, users may recognize that authors tend to use PDF format for longer works and as a result such experienced users may select or reject one classification or the other depending on the depth of their search. However, less experienced users may be unable to make this inference and regardless, being a mere weak inference by the user, it will be less certain and less helpful than an explicit ordering promised by a content 154 provider.

Furthermore, when other common data types are included in the classification scheme, for example TIF, MP3, MPEG formats (which don't share the same weak relationship), it will be appreciated that this classification actually helps users more to filter than to scope. For example, the MP3 classification might include audio files with more in-depth information than either the HTML files or the PDF files; however, there is no inference that would suggest this outcome and with mere classification instead of ordering there is no other aid to guide the user.

In implementation, ordering might be anticipatory or actual. In other words, the subsets 176 might be ordered based upon characteristics of their respective corresponding search engines 106 before the actual search results have come into existence, or else the subsets 176 might be ordered based upon their own actual characteristics once they have been populated.

Experts in searching various domains develop the ability to predict in advance what search engine 106 and query 182 is most likely to return results of a particular focus, scope or character. Thus experience or logic might anticipate that three search engines 106 will return respectively broad, moderate and narrow search results when searching the same keywords 168. For example, the broad search engine 106 might be configured to return a results subset 176 of content 154 having payload 156 that includes any of the keywords 168; the moderate search engine 106 might be configured to return a results subset 176 of content 154 having payload 156 that includes all of the keywords 168; the narrow search engine 106 might be configured to return a results subset 176 of content 154 having payload 156 that includes only the keywords 168 arranged in a specific phrase. To similar effect, three queries 182 of varying scope might be provided to the same search engine 106.

Alternatively, the ordering might be performed on the actual subsets 176 once they have been populated. Thus for example, where subsets 176 are being ordered from local to global, one could analyze the indicant 158 pointers 160 as a measure of where the corresponding content item 154 was being served from or the indicant 158 representations 162 for geographic words and then order each of the subsets 176 based on the proportion of global to local content 154 of its members indicants 158.

FIG. 5 also illustrates some other convenient features. To help with preprocessing, the first embodiment page 172 also provides a query box 184 for entering a uniform set of keywords 168 for all searches and a search button 186 to engage the multiple search engines 106 in searching the keywords 168 entered in the query box 184.

FIG. 6 shows a second embodiment page 188 of search results served by the web server 108 to the web browser 110 incorporating a set of search results 166 from multiple search engines 106.

As before, the set of search results 166 is the union of the search result subsets 176 returned by the respective search engines 106. The search results subsets 176 are presented together but distinctly on the second embodiment page 188 of search results, with a respective cue 178 indicating the correspondence between each of the search result subsets 176 and its respective search engine 106. As illustrated, each of the search result subsets 176 is presented in its own window 140 and all the windows 140 are presented adjacently. As illustrated, the cue 178 for each subset 176 is a window 140 title (Broad, Narrow, Medium) and the position of the window 140 (left, middle, right).

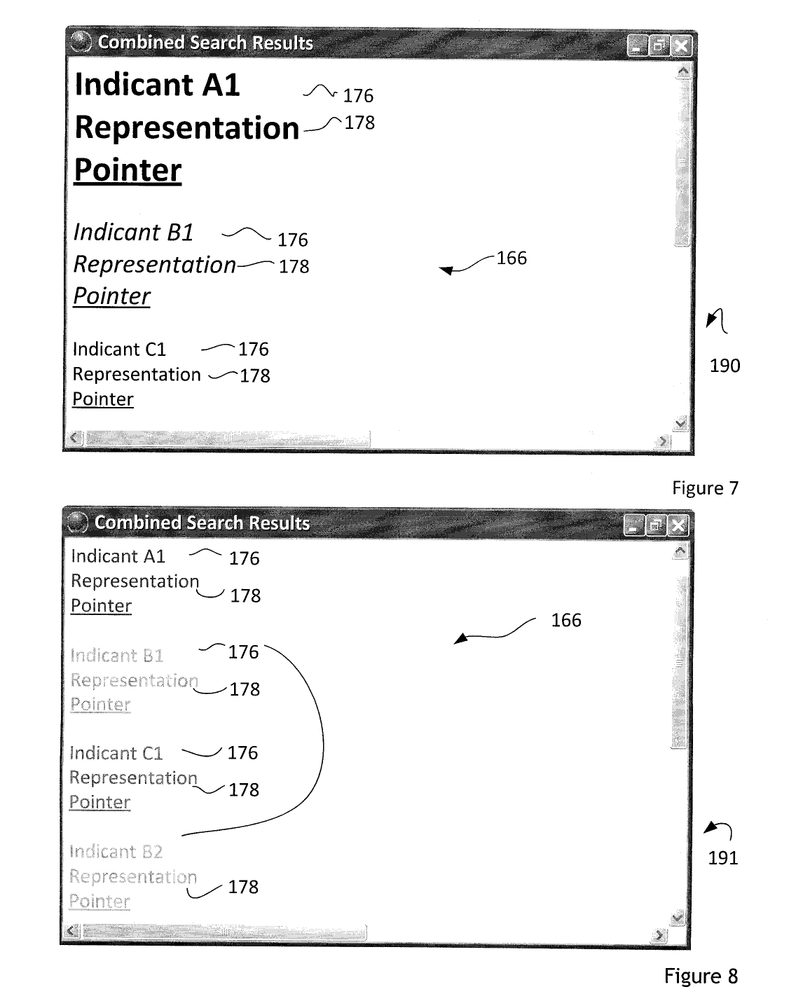

FIG. 7 shows a third embodiment page 190 of search results served by the web server 108 to the web browser 110 incorporating a set of search results 166 from multiple search engines 106.

As before, the set of search results 166 is the union of the search result subsets 176 returned by the respective search engines 106. The search results subsets 176 are presented together but distinctly on the third embodiment page 190 of search results, with a respective cue 178 indicating the correspondence between each of the search result subsets 176 and its respective search engine 106. As illustrated, each of the search result subsets 176 is presented intermingled in the same scrollable list in the same window 140. As illustrated, the cue 178 for each subset 176 is type, with Search A being depicted in bold 24-point type, Search B being depicted in italic point type, and Search C being depicted in plain 12-point type. Those skilled in the art will recognize that fonts could also act as cues 178, with some thought given to how to represent order, for example a progression from ornately serifed to sans serif.

FIG. 8 shows a fourth embodiment page 191 of search results served by the web server 108 to the web browser 110 incorporating a set of search results 166 from multiple search engines 106.

As before, the set of search results 166 is the union of the search result subsets 176 returned by the respective search engines 106. The search results subsets 176 are presented together but distinctly on the fourth embodiment page 191 of search results, with a respective cue 178 indicating the correspondence between each of the search result subsets 176 and its respective search engine 106. As illustrated, each of the search result subsets 176 is presented intermingled in the same scrollable list in the same window 140. As illustrated, the cue 178 for each subset 176 is color, with Search A being depicted in red, Search B being depicted in italic yellow, and Search C being depicted in green. Those skilled in the art will recognize that some thought can be given to how to represent order to make the order easier for a user to recognize and remember, for example, the traffic light order depicted in FIG. 8, the order of the spectrum, lightest to darkest or otherwise. However, none of the cues 178 as taught need to follow a conventionally accepted order.

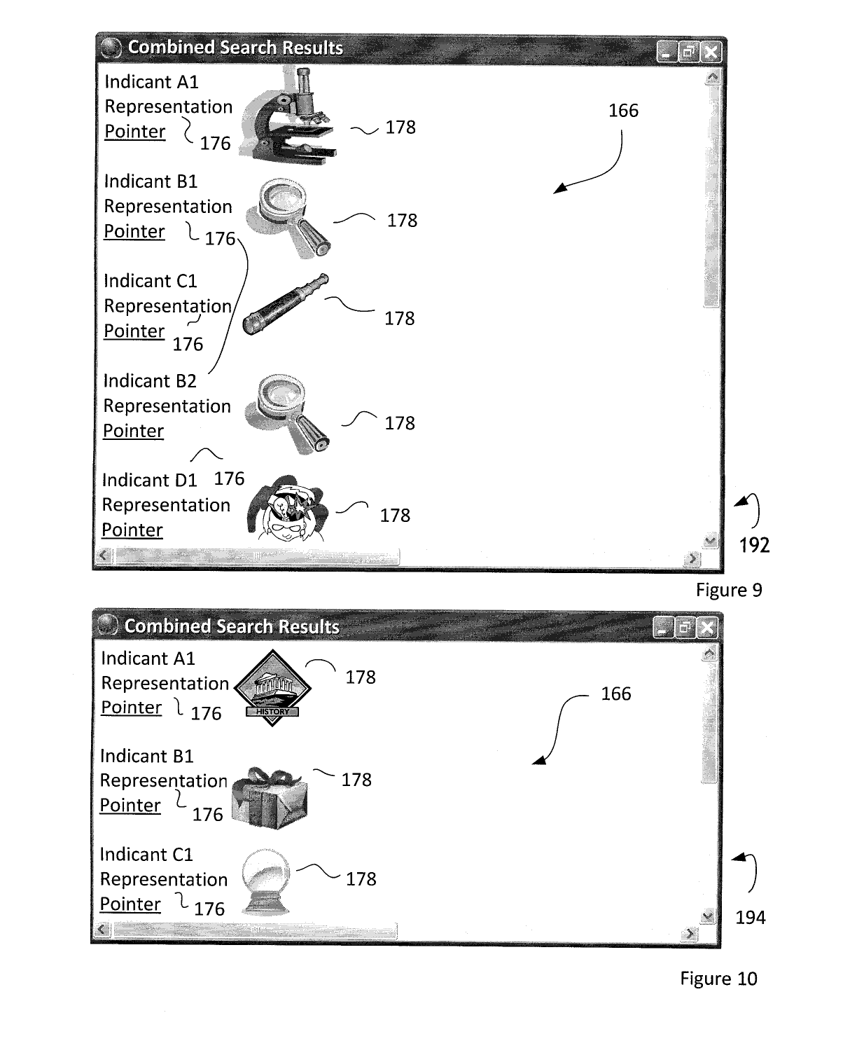

Similarly, FIGS. 9 to 12 show respectively a fifth embodiment page 192 of search results, a sixth embodiment page 194 of search results, a seventh embodiment page 196 of search results and an eighth embodiment page 198 of search results, each served by the web server 108 to the web browser 110 incorporating a set of search results 166 from multiple search engines 106.

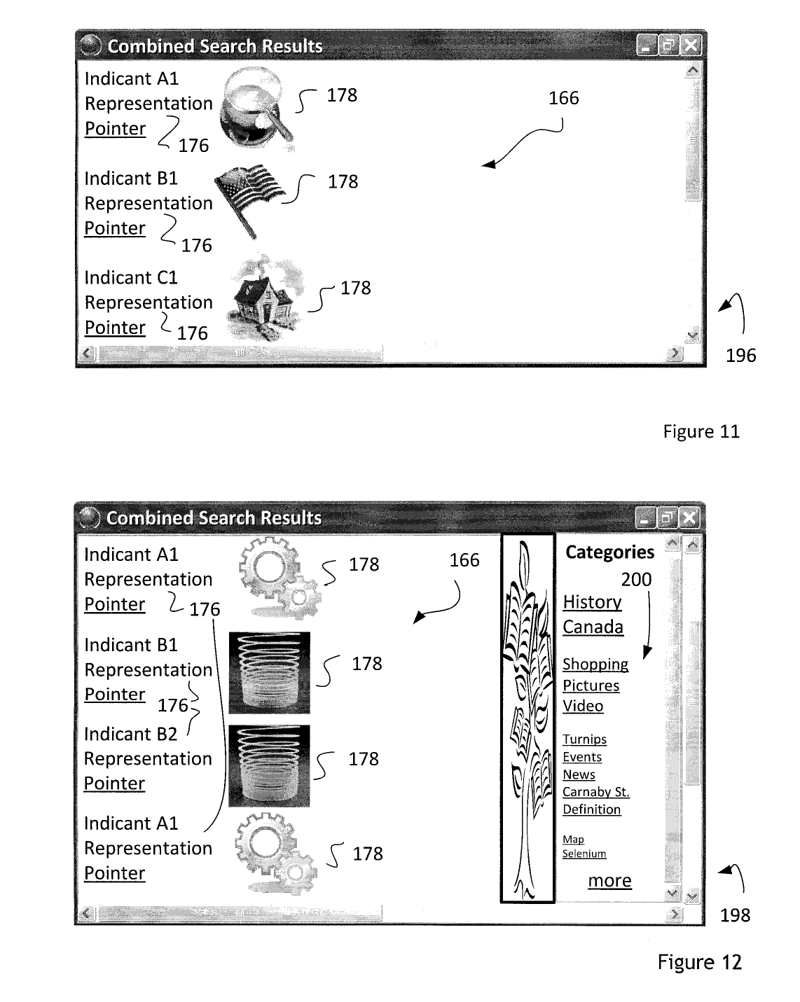

As before, the set of search results 166 is the union of the search result subsets 176 returned by the respective search engines 106. The search results subsets 176 are presented together but distinctly on these pages of search results, with a respective cue 178 indicating the correspondence between each of the search result subsets 176 and its respective search engine 106. As illustrated, each of the search result subsets 176 is presented intermingled in the same scrollable list in the same window 140. As illustrated, the cue 178 for each subset 176 is a distinguishing indicia 178 such as an icon 178. In FIG. 9 where the order is investigative to exploratory, the icons 178 progress from a microscope to a magnifying glass to a telescope to a brain primed for lateral thinking. In FIG. 10 where the order is historical to future-focused, the icons 178 progress from a Greek temple to a current “present” to a crystal ball. In FIG. 11 where the order is global to local, the icons 178 progress from a globe to the national flag of the United States of America to a house. In FIG. 12 where the order is results tightly-related to the keywords 168 searched to results loosely-related to the keywords 168 searched, the icons 178 progress from a gear train to a relaxed spring.

FIG. 12 may be seen as ordering a search engine 106 result subset 176 (tightly-related to the keywords 168 searched) and recommendation engine result subset 176 (loosely-related to the keywords 168 searched). In this regard, this ordering is similar to ordering from analytic to synthetic, from deductive to inductive, from investigative to explorative, from literal to lateral, or from denotative to connotative. In other words, the personalized results are likely to include things of significant interest to the user that were not the generic focus of the literal search and that would not likely be relevant or of interest to a generic user.

In implementation, the personalized results might be either machine-selected, human-selected or a hybrid. They might be personalized on the same basis as everyone else or else personalized by comparing the user to others of similar or dissimilar interests. The user's preferences might be discovered either explicitly—for example through questionnaire, member profile, or query 182 history—or implicitly through behavior—for example click-through or page-view behavior.

FIG. 12 also illustrates some other convenient features. To help with post-processing, the eighth embodiment page 198 also provides a scrollable list of user-selectable labels 200 representing categories 180 of indicants 158 in the result set 166 as a whole or in one or more of the subsets 176, for example just the subset 176 of results from the recommender engine. The labels 200 can be formatted to indicate the relative numbers of members in each category 180, such that crowded categories 180 are represented by labels 200 that are bold, italic, large, brightly colored or the like. As will be described in greater detail below, by selecting one of the labels 200, the user can re-execute the searches with a bias toward the category 180 represented by the label 200 selected.

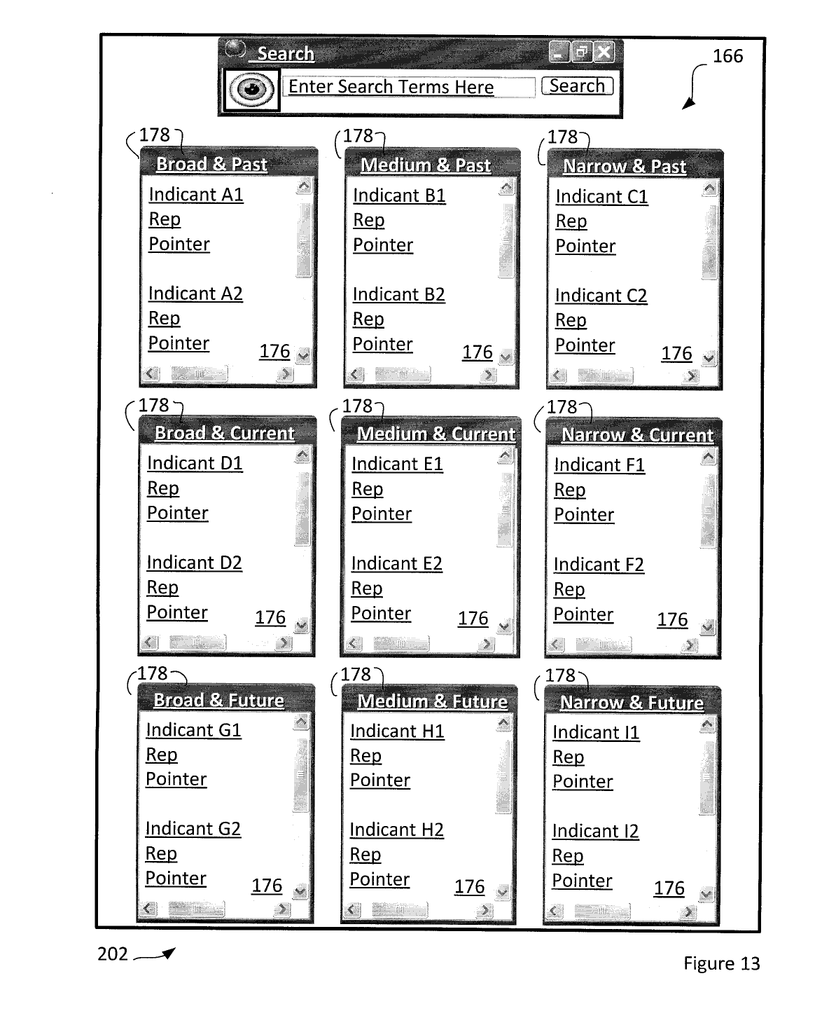

FIG. 13 shows a ninth embodiment page 202 of search results served by the web server 108 to the web browser 110 incorporating a set of search results 166 from multiple search engines 106.

As before, the set of search results 166 is the union of the search result subsets 176 returned by the respective search engines 106. The search results subsets 176 are presented together but distinctly on the ninth embodiment page 202 of search results, with a respective cue 178 indicating the correspondence between each of the search result subsets 176 and its respective search engine 106. As illustrated, each of the search result subsets 176 is presented in its own window 140 and all the windows 140 are presented as a two-dimensional matrix. As illustrated, the cue 178 for each subset 176 is a window 140 title (Broad & Past, Medium & Past, Narrow & Past, Broad & Current, Medium & Current, Narrow & Current, Broad & Future, Medium & Future, Narrow & Future) and the position of the window 140 (top left, top middle, top right, middle left, middle middle, middle right, bottom left, bottom middle, bottom right).

Thus the ninth embodiment page 202 is an example of ordering results along more than one dimension. Those skilled in the art will appreciate that subsets 176 can be usefully ordered along more than one dimension without fully populating all positions in the order; for example, in the example illustrated on might choose not to include a “Broad & Past” subset 176.

2. Operation

The embodiments presented attempt to illustrate broadly some of the many ways of serving a page that presents the subsets 176, ordered with respect to each other according to scope, together but distinctly such that each subset 176 presents a distinct cue 178 to its respective scope. Those skilled in the art will recognize there are many ways to implement this page service. The subsets 176 might be contained in a singled HTML document retrieved by a single HTTP request. The subsets 176 might be contained in the same HTML document, retrieved by multiple concurrent or non-concurrent HTTP requests (i.e. AJAX). Each subset 176 might be contained in a respective HTML document, but displayed on the same page using Frames or IFrames. Each subset 176 might be contained in a respective HTML document, but displayed together in multiple adjacent browser windows 140.

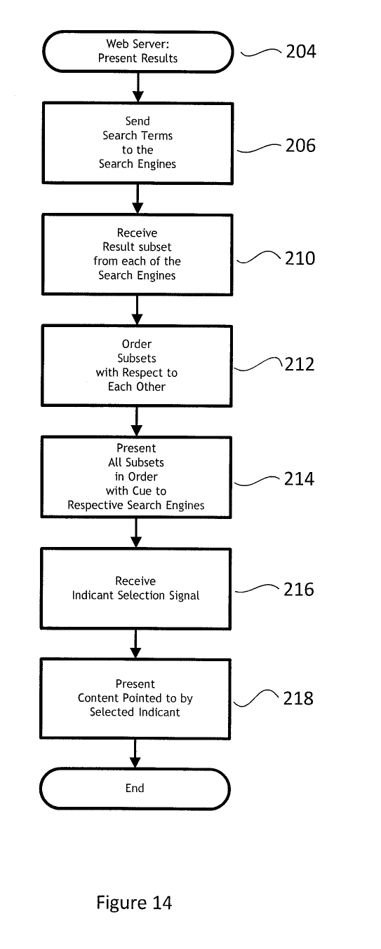

FIG. 14 illustrates a presentation process 204 executable by the processor 122 of the web server 108 to provide the functionality described above in accordance with stored instructions. These instructions may be encoded in the RAM 134, ROM 132, mass storage 130 or a signal received via the network interface 136 of the web server 108.

Those skilled in the art will understand that in an internetworked system 100 an action is often the result of coordinated activities occurring at multiple nodes in the system 100. In the case of a system 100 built on the Internet 104, these nodes are often distributed ad hoc and unpredictably across multiple jurisdictions. The actions as described and claimed herein are intended to encompass at least: (a) actions performed directly and completely within the jurisdiction of the patent, (b) actions coordinated within the jurisdiction but with at least some activities performed outside the jurisdiction, (c) actions coordinated outside the jurisdiction but with at least some activities performed within the jurisdiction, and (d) actions performed for the benefit of a node within the jurisdiction or a person using that node. An example of such coordination would be serving a layout for a web page from one node and serving content 154 for insertion into the layout from one or more other nodes, including through the use of server-side scripting, client-side scripting, and AJAX techniques.

The presentation process 204 begins with a query step 206, in which the web server 108 receives search terms 168 from a user, formulates those search terms 168 into appropriate queries 182 for the search engines 106 to be searched, and sends the respective queries 182 to the respective search engines 106 that, each according to its own methodology, search a universe of content items 154.

The invention is widely applicable and not restricted to use with only specialized datasets. In this regard, all the search engines 106 might search the whole universe or else at least some of the search engines 106 might search sub-universes. In the case where each search engine 106 searches a sub-universe, then the universe would be the union of these sub-universes. The sub-universes might be related, such that for example: (a) two of the sub-universes have a non-null intersection set, or (b) each of the sub-universes has a non-null intersection set with at least one other of the sub-universes, or (c) each pair of sub-universes has a non-null intersection set, or (d) each pair of sub-universes has an intersection set that is identical to one of the pair. More concretely, the invention is applicable to open resources on the public Internet 104, to proprietary resources in accessible private and semi-private domains connected to an internetwork 104 such as the Internet 104, and to various combinations thereof.

In a collection step 210, the web server 108 receives respective result subsets 176 back from the search engines 106 and in an ordering step 212 the web server 108 orders each of the subsets 176 with respect to the other subsets 176 along one or more predetermined axes, as described above, for example narrow to broad.

In a results presentation step 214, the web server 108 assembles a page for presentation on a video display 128 at the user's web browser 110 under the control of a web browser 110 program that presents the ordered subsets 176 together but distinctly on the video display 128, such that a cue 178 indicates which subset 176 is associated with which search engine 106 or more generally which query 182. More specifically, what is presented are the indicant 158 representations 162 of the content items 154 identified by the search engines 106.

The presentation process 204 further provides for an indicant-selection step 216, in which the web server 108 receives a signal from the web browser 110 indicating that the user selected one particular indicant 158 in one of the subsets 176 presented—conventionally by using a selection device 126 such as a mouse 126 in combination with the video display 128.

In a content presentation step 218, the web server 108 serves to the web browser 110 the payload 156 at the pointer 160 associated with the selected indicant 158. Those skilled in the art will recognize that as an alternative implementation, at the results presentation step 214 the web server 108 might have served pointers 160 together with respective indicants 158 so that payloads 156 could be access directly by the web browser 110.

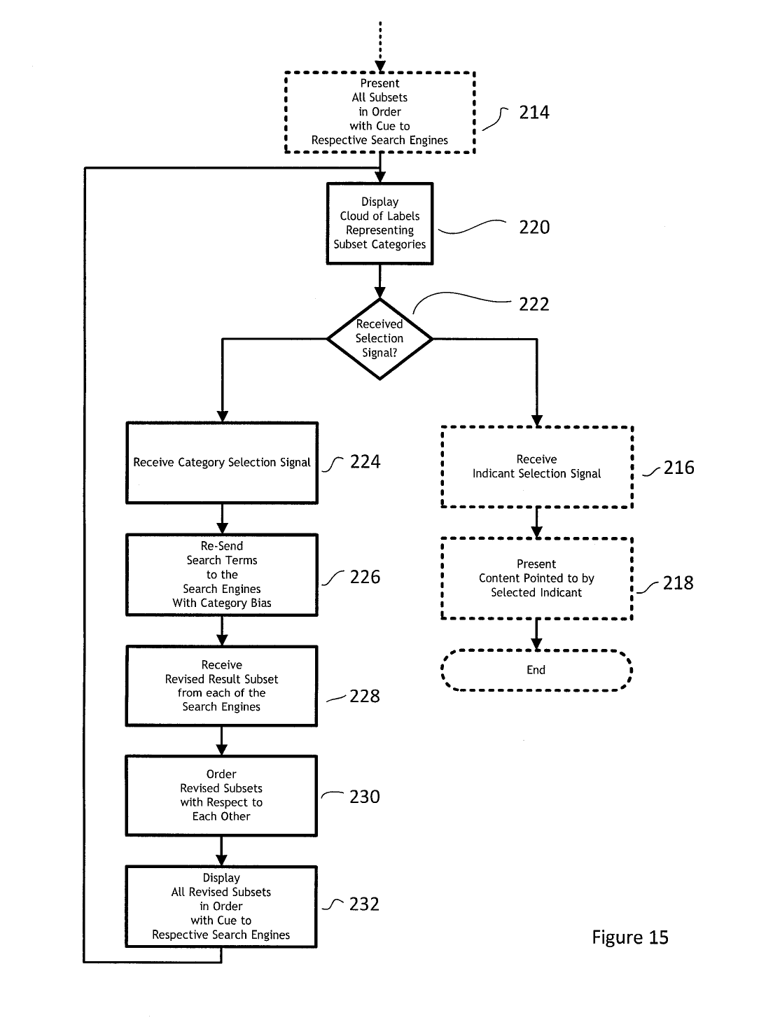

FIG. 15 illustrates an elaboration of the presentation process 204 shown in FIG. 14. In general, it provides the user with the ability to search iteratively, using the result set 166 of a current iteration to focus the queries 182 of a next iteration.

In this elaboration, after the results presentation step 214, there is a category presentation step 220, in which the web server 108 identifies categories 180 of indicants 158 in the result set 166 and presents a group of labels 200 representing the categories 180 along with the result set 166.

In a user-signal detection step 222, the web server 108 detects signals from the user of the web browser 110 and distinguishes between an indicant-selection signal as described above with respect to the indicant-selection step 216 and a category-selection signal. If the former is detected, then the indicant-selection step 216 and following steps are performed as described above. Alternatively, if a category-selection signal is detected, then a category-selection step 224 is performed.

In the category-selection step 224, the web server 108 receives a signal from the web browser 110 indicating that the user selected one particular category 180 label 200—conventionally by using a selection device 126 such as a mouse 126 in combination with the video display 128.

In a revised query step 226, the web server 108 receives reformulates the search terms 168 into appropriate queries 182 for the search engines 106 to be searched, biasing the queries 182 toward the category 180 associated with the selected label 200, and sends the respective reformulated queries 182 to the respective search engines 106.

In a revised collection step 228, the web server 108 receives respective revised result subsets 176 back from the search engines 106 and in a revised ordering step 230 the web server 108 orders each of the revised subsets 176 with respect to the other revised subsets 176 along the predetermined axis.

In a revised results presentation step 232, the web server 108 assembles a page for presentation on the video display 128 at the user's web browser 110 under the control of the web browser 110 program that presents the ordered revised subsets 176 together but distinctly on the video display 128, such that a cue 178 indicates which subset 176 is associated with which search engine 106 or more generally which query 182. More specifically, what is presented are the indicant 158 representations 162 of the content items 154 identified by the search engines 106.

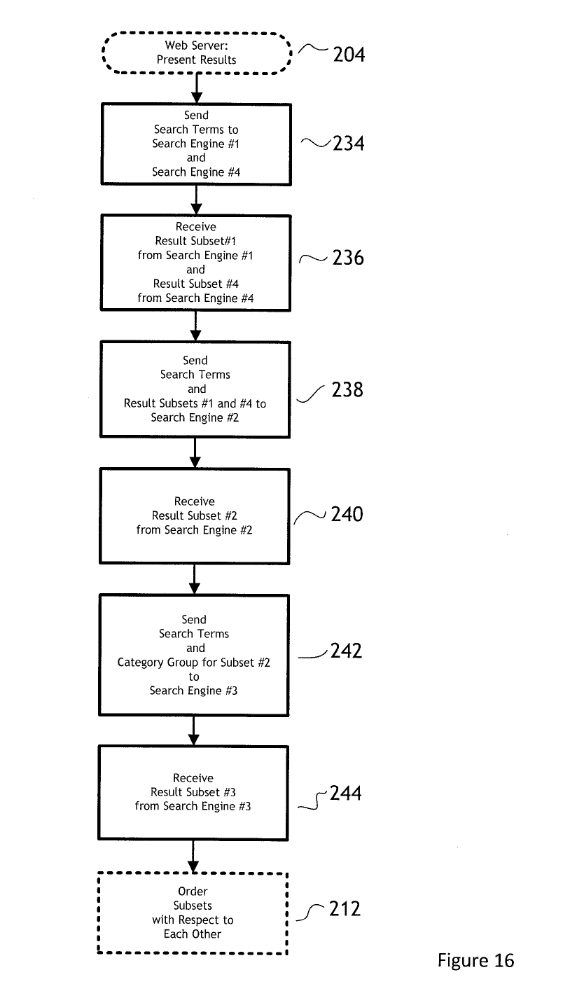

FIG. 16 illustrates a further elaboration of the presentation process 204 shown in FIG. 14. In general, it provides a feed-forward capability in which some early queries 182 are conducted before some late queries 182 so that the result subsets 176 of the early queries 182 can be fed-forward in whole, in part, or after processing, for incorporation into the late queries 182. It will be understood that there may sometimes be advantages in feeding back results from late queries 182 to better re-execute early queries 182. There may also be situations where one wants to stagger queries 182 in time without applying feed-forward or feedback techniques. Those skilled in the art will recognize the many variations of such schemes and will understand that the process detailed below is merely exemplary.

In a feed-forward first query step 234, the web server 108 receives search terms 168 from a user, formulates those search terms 168 into appropriate queries 182 for a first group of search engines 106 to be searched, and sends the respective queries 182 to the respective search engines 106. In general, it is expected that each of the respective search engines 106 will search the same universe of content items 154 according to its own methodology.

In a feed-forward first collection step 236, the web server 108 receives respective result subsets 176 back from each of the first group of search engines 106.

In a feed-forward second query step 238, the web server 108 formulates the search terms 168 and the result subsets 176 received from the first group of search engines 106 into appropriate queries 182 for a second group of search engines 106 to be searched, and sends the respective queries 182 to the respective search engines 106.

In a feed-forward second collection step 240, the web server 108 receives respective result subsets 176 back from each of the second group of search engines 106.

In a feed-forward third query step 242, the web server 108 formulates the search terms 168 and categories 180 of the subsets 176 received from the second group of search engines 106 into appropriate queries 182 for a third group of search engines 106 to be searched, and sends the respective queries 182 to the respective search engines 106.

In a feed-forward third collection step 244, the web server 108 receives respective result subsets 176 back from each of the third group of search engines 106.

All of the subsets 176 are then ordered in accordance with the ordering step 212 illustrated in FIG. 14.

Thus it will be seen that the present invention teaches a method of presenting a result set 166 of a plurality of searches of a universe of content 154, the plurality of searches returning respective result subsets 176 of indicants 158 that in union form the result set 166, by ordering the subsets 176 with respect to each other according to scope and serving a page that presents the ordered subsets 176 together but distinctly, such that at least a portion of each subset 176 is visible and each subset 176 presents a distinct cue 178 to its respective scope.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A method of presenting a result set (166) of a plurality of searches of a universe of content (154), the plurality of searches returning respective result subsets (176) of indicants (158) that in union form the result set (166), comprising:
serving a page that presents the subsets (176), ordered in relation to each other according to scope, together but distinctly such that each subset (176) presents a distinct cue (178) to its respective scope.

2. A method as set forth in claim 1 wherein the universe is the union of respective sub-universes searched by a respective one of the plurality of searches.

3. A method as set forth in claim 2 wherein two of the respective sub-universes have a non-null intersection set.

4. A method as set forth in claim 3 wherein each of the respective sub-universes has a non-null intersection set with at least one other of the respective sub-universes.

5. A method as set forth in claim 4 wherein each pair of respective sub-universes has a non-null intersection set.

6. A method as set forth in claim 5 wherein each pair of respective sub-universes has an intersection set that is identical to one of the pair.

7. A method as set forth in claim 1, wherein each of the plurality of searches operates on the same search terms (168).

8. A method as set forth in claim 7, wherein each of the plurality of searches operates on the same query (182).

9. A method as set forth in claim 1, wherein presenting the ordered subsets (176) together but distinctly includes presenting the ordered subsets (176) adjacently on the page such that the cue (178) is position.

10. A method as set forth in claim 9, wherein presenting the ordered subsets (176) together but distinctly includes presenting the ordered subsets (176) in respective windows (140) on the same page.

11. A method as set forth in claim 1, wherein presenting the ordered subsets (176) together but distinctly includes presenting each of the ordered subsets (176) adjacent to a respective distinguishing indicia (178).

12. A method as set forth in claim 1, wherein presenting the ordered subsets (176) together but distinctly includes presenting each of the ordered subsets (176) in a respective distinguishing color.

13. A method as set forth in claim 1, wherein presenting the ordered subsets (176) together but distinctly includes presenting each of the ordered subsets (176) in a respective distinguishing font.

14. A method as set forth in claim 1 further comprising ordering the subsets (176) in relation to each other according to scope.

15. A method as set forth in claim 14, wherein ordering the subsets (176) includes ordering the subsets (176) in the order of the respective searches.

16. A method as set forth in claim 14, wherein ordering the subsets (176) includes ordering the subsets (176) from more broad to more narrow.

17. A method as set forth in claim 14, wherein ordering the subsets (176) includes ordering the subsets (176) from more deep to more shallow.

18. A method as set forth in claim 14, wherein ordering the subsets (176) includes ordering the subsets (176) from more analyzed to more synthesized.

19. A method as set forth in claim 14, wherein ordering the subsets (176) includes ordering the subsets (176) from more deduced to more induced.

20. A method as set forth in claim 14, wherein ordering the subsets (176) includes ordering the subsets (176) from more investigative to more explorative.

21. A method as set forth in claim 14, wherein ordering the subsets (176) includes ordering the subsets (176) from more tightly-related to the keywords (168) searched to more loosely-related to the keywords (168) searched.

22. A method as set forth in claim 14, wherein ordering the subsets (176) includes ordering the subsets (176) from more literal to more lateral.

23. A method as set forth in claim 14, wherein ordering the subsets (176) includes ordering the subsets (176) from more denotative to more connotative.

24. A method as set forth in claim 14, wherein ordering the subsets (176) includes ordering the subsets (176) from more general to more personal.

25. A method as set forth in claim 14, wherein ordering the subsets (176) includes ordering the subsets (176) from more concrete to more abstract.

26. A method as set forth in claim 14, wherein ordering the subsets (176) includes ordering the subsets (176) from in a larger proportion machine-selected to in a larger proportion human-selected.

27. A method as set forth in claim 14, wherein ordering the subsets (176) includes ordering the subsets (176) from more factual to more speculative.

28. A method as set forth in claim 14, wherein ordering the subsets (176) includes ordering the subsets (176) from more historical to more future-oriented.

29. A method as set forth in claim 14, wherein ordering the subsets (176) includes ordering the subsets (176) from more global to more local.

30. A method as set forth in claim 14, wherein ordering the subsets (176) includes ordering the subsets (176) more simple to more complicated.

31. A method as set forth in claim 14, wherein ordering the subsets (176) includes ordering the subsets (176) from shorter to longer.

32. A method as set forth in claim 14, wherein ordering the subsets (176) includes ordering the subsets (176) from more objective to more subjective.

33. A method as set forth in claim 14, wherein ordering the subsets (176) includes ordering the subsets (176) from more related to the keywords (168) searched to more related to the user's broader interests.

34. A method as set forth in claim 14, wherein ordering the subsets (176) includes ordering the subsets (176) from more factual to more opinionated.

35. A method as set forth in claim 14, wherein ordering the subsets (176) includes ordering the subsets (176) from deterministic in a larger proportion to probabilistic in a larger proportion.

36. A method as set forth in claim 14, wherein ordering the subsets (176) includes ordering the subsets (176) from more descriptive to more prescriptive.

37. A method as set forth in claim 14, wherein ordering the subsets (176) includes ordering the subsets (176) from more structured to more random.

38. A method as set forth in claim 14, wherein ordering the subsets (176) includes ordering the subsets (176) from more popular to more specialist.

39. A method as set forth in claim 14, wherein ordering the subsets (176) includes ordering the subsets (176) from more biased to more neutral.

40. A method as set forth in claim 14, wherein ordering the subsets (176) includes ordering the subsets (176) from more emotional to more rational.

41. A method as set forth in claim 14, wherein ordering the subsets (176) includes ordering the subsets (176) from more dormant to more active.

42. A method as set forth in claim 14, wherein ordering the subsets (176) includes ordering the subsets (176) from more controlled to more open.

43. A method as set forth in claim 14, wherein ordering the subsets (176) includes ordering the subsets (176) from unilingual in larger proportion to unilingual in smaller proportion.

44. A method as set forth in claim 14, wherein ordering the subsets (176) includes ordering the subsets (176) from more corporate to more personal.

45. A method as set forth in claim 14, wherein ordering the subsets (176) includes ordering the subsets (176) from more corporate to more academic.

46. A method as set forth in claim 14, wherein ordering the subsets (176) includes ordering the subsets (176) from more closely identified with a first ideology to more closely identified with a second ideology.

47. A method as set forth in claim 14, wherein ordering the subsets (176) includes ordering the subsets (176) from more innocent to more mature.

48. A method as set forth in claim 14, wherein ordering the subsets (176) includes ordering the subsets (176) from more fictional to more factual.

49. A method as set forth in claim 14, wherein ordering the subsets (176) includes ordering the subsets (176) from personalized on the same basis as everyone in larger proportion to more personalized by comparison to others in larger proportion.

50. A method as set forth in claim 14, wherein ordering the subsets (176) includes ordering the subsets (176) from implicitly preferenced in larger proportion to explicitly preferenced in larger proportion.

51. A method as set forth in claim 14 wherein ordering the subsets (176) includes ordering the subsets (176) from interpreting the query (182) more lexically to interpreting the query (182) more semantically.

52. A method as set forth in claim 14, wherein ordering the subsets (176) includes ordering the subsets (176) according to more than one dimension of scope.

53. A system (100) for presenting a result set (166) of a plurality of searches of a universe of content (154), the plurality of searches returning respective result subsets (176) of indicants (158) that in union form the result set (166), comprising:
means for serving a page that presents the subsets (176), ordered in relation to each other according to scope, together but distinctly such that each subset (176) presents a distinct cue (178) to its respective scope.

54. A computer-readable medium having computer-executable instructions for performing a method of presenting a result set (166) of a plurality of searches of a universe of content (154), the plurality of searches returning respective result subsets (176) of indicants (158) that in union form the result set (166), comprising:
serving a page that presents the subsets (176), ordered in relation to each other according to scope, together but distinctly such that each subset (176) presents a distinct cue (178) to its respective scope.

55. A carrier wave communicating a computer-readable signal encoding computer-executable instructions for performing a method of presenting a result set (166) of a plurality of searches of a universe of content (154), the plurality of searches returning respective result subsets (176) of indicants (158) that in union form the result set (166), comprising:
serving a page that presents the subsets (176), ordered in relation to each other according to scope, together but distinctly such that each subset (176) presents a distinct cue (178) to its respective scope.

56. A method of presenting a result set (166) of a plurality of keyword (168) searches of content (154), the plurality of searches returning respective result subsets (176) of indicants (158) that in union form the result set (166), comprising:
serving a page that presents the subsets (176), ordered in relation to each other according to scope from tightly-related to the keywords (168) searched to loosely-related to the keywords (168) searched, together but distinctly such that each subset (176) presents a distinct cue (178) to its respective scope.

57. A method as set forth in claim 56, wherein serving a page includes serving a page that presents user-selectable labels (200) representing categories (180) of indicants (158) in the result set (166).

58. A method as set forth in claim 57, wherein serving a page includes serving a page that presents user-selectable labels (200) representing categories (180) of indicants (158) in at least one of the subsets (176).

59. A method as set forth in claim 58, wherein serving a page includes serving a page that presents user-selectable labels (200) representing categories (180) of indicants (158) in the one of the subsets (176) that is most loosely-related to the keywords (168) searched.
